(19) United States
(12) Patent Application Publication
(10) Pub. No.: US 2017/0310994 A1
(43) Pub. Date: Oct. 26, 2017

(54) 3D VIDEO CODING METHOD AND DEVICE

(71) Applicant: LG ELECTRONICS INC., Seoul (KR)

(72) Inventors: Jungdong Seo, Seoul (KR); Sehoon Yea, Seoul (KR); Sunmi Yoo, Seoul (KR); Junghak Nam, Seoul (KR)

(21) Appl. No.: 15/517,792

(22) PCT Filed: Oct. 6, 2015
(86) PCT No.: PCT/KR2015/010555

§ 371 Date: Apr. 7, 2017

Related U.S. Application Data
(60) Provisional application No. 62/061,159, filed on Oct. 8, 2014.

(51) Int. Cl. H04N 19/597; H04N 19/593

(52) U.S. Cl. CPC H04N 19/597; H04N 19/593

(57) ABSTRACT

The present invention relates to a device and method for coding a 3D video, and a decoding method according to the present invention comprises the steps of: decoding information on an intra-skip mode for a current block; deriving, as the intra-skip mode, a prediction mode of the current block on the basis of the information on the intra-skip mode; generating a candidate list for the intra-skip mode; and generating a reconstruction sample of the current block on the basis of the candidate list. The present invention can reduce the amount of data to be transmitted and improve coding efficiency by coding a current block on the basis of an intra-skip mode in 3D video coding. In addition, the present invention can perform an intra-skip mode procedure on the basis of an intra-directional mode using a neighboring block in 3D video coding, and reconstruct the current block without a residual signal.

### CROSS-REFERENCE TO RELATED APPLICATIONS

This application is the National Stage filing under 35 U.S.C. 371 of International Application No. PCT/KR2015/010555, filed on Oct. 6, 2015, which claims the benefit of U.S. Provisional Application No. 62/061,159 filed on Oct. 8, 2014, the contents of which are all hereby incorporated by reference herein in their entirety.

### BACKGROUND OF THE INVENTION

### Field of the Invention

The present invention relates to a technology associated with video coding, and more particularly, to coding of a 3D video.

### Related Art

In recent years, demands for a high-resolution and high-quality video have increased in various fields of applications. However, the higher the resolution and quality video data becomes, the greater the amount of video data becomes.

Accordingly, when video data is transferred using media such as existing wired or wireless broadband lines or video data is stored in existing storage media, the transfer cost and the storage cost thereof increase. High-efficiency video compressing techniques can be used to effectively transfer, store, and reproduce high-resolution and high-quality video data.

On the other hand, with realization of capability of processing a high-resolution/high-capacity video, digital broadcast services using a 3D video have attracted attention as a next-generation broadcast service. A 3D video can provide a sense of realism and a sense of immersion using multi-view channels.

A 3D video can be used in various fields such as free viewpoint video (FVV), free viewpoint TV (FTV), 3DTV, surveillance, and home entertainments.

Unlike a single-view video, a 3D video using multi-views has a high correlation between views having the same picture order count (POC). Since the same scene is shot with multiple neighboring cameras, that is, multiple views, multi-view videos have almost the same information except for a parallax and a slight illumination difference and thus difference views have a high correlation therebetween.

Accordingly, the correlation between different views can be considered for coding/decoding a multi-view video, and information need for coding and/or decoding of a current view can be obtained. For example, a block to be decoded in a current view can be predicted or decoded with reference to a block in another view.

### SUMMARY OF THE INVENTION

The present invention provides a method and apparatus for predicting a current block in 3 dimensional (3D) video coding.

The present invention provides a coding method and apparatus based on an intra skip mode in 3D video coding.

The present invention provides a method and apparatus for deriving a candidate list for an intra skip mode by using a neighboring block or neighboring sample of a current block.

According to an embodiment of the present invention, a 3D video decoding method is provided. The method includes: decoding information on an intra skip mode for a current block; deriving a prediction mode of the current block as the intra skip mode on the basis of the information on the intra skip mode; generating a candidate list for the intra skip mode; and generating a reconstruction sample of the current block on the basis of the candidate list.

According to another embodiment of the present invention, a 3D video decoding apparatus is provided. The decoding apparatus includes: a decoder for decoding information on an intra skip mode for a current block; and a predictor for deriving a prediction mode of the current block as the intra skip mode on the basis of the information on the intra skip mode, for generating a candidate list for the intra skip mode, and for generating a reconstruction sample of the current block on the basis of the candidate list.

According to the present invention, coding efficiency can be improved by coding a current block on the basis of an intra skip mode in 3 dimensional (3D) video coding, and an amount of data to be transmitted can be decreased.

According to the present invention, an intra skip mode procedure can be performed on the basis of an intra directional mode by using a neighboring block in 3D video coding, and a current block can be reconstructed without a residual signal.

### BRIEF DESCRIPTION OF THE DRAWINGS

FIG. 1 briefly illustrates a 3 dimensional (3D) video encoding and decoding process to which the present invention is applicable.

FIG. 2 briefly illustrates a structure of a video encoding device to which the present invention is applicable.

FIG. 3 briefly illustrates a structure of a video decoding device to which the present invention is applicable.

FIG. 4 is a diagram for schematically describing an intra prediction method of a current block in a depth map in a single depth mode (SDM).

FIG. 5 is a flowchart briefly illustrating an encoding method based on an intra skip mode according to an embodiment of the present invention.

FIG. 6 is a flowchart briefly illustrating a decoding method based on an intra skip mode according to an embodiment of the present invention.

### DESCRIPTION OF EXEMPLARY EMBODIMENTS

The invention may be variously modified in various forms and may have various embodiments, and specific embodiments thereof will be illustrated in the drawings and described in detail. However, these embodiments are not intended for limiting the invention. Terms used in the below description are used to merely describe specific embodiments, but are not intended for limiting the technical spirit of the invention. An expression of a singular number includes an expression of a plural number, so long as it is clearly read differently. Terms such as “include” and “have” in this description are intended for indicating that features, numbers, steps, operations, elements, components, or combinations thereof used in the below description exist, and it should be thus understood that the possibility of existence or addition of one or more different features, numbers, steps, operations, elements, components, or combinations thereof is not excluded.

On the other hand, elements of the drawings described in the invention are independently drawn for the purpose of convenience of explanation on different specific functions, and do not mean that the elements are embodied by independent hardware or independent software. For example, two or more elements out of the elements may be combined to form a single element, or one element may be split into plural elements. Embodiments in which the elements are combined and/or split belong to the scope of the invention without departing from the concept of the invention.

Hereinafter, embodiments of the present invention will be described in detail with reference to the accompanying drawings. In addition, like reference numerals are used to indicate like elements throughout the drawings, and the same descriptions on the like elements will be omitted.

In the present specification, a pixel or a pel may mean a minimum unit constituting one picture (or image). Further, a ‘sample’ may be used as a term representing a value of a specific pixel. The sample may generally indicate a value of the pixel, may represent only a pixel value of a luma component, and may represent only a pixel value of a chroma component.

A unit indicates a basic unit of image processing. The unit may include at least one of a specific area and information related to the area. Optionally, the unit may be mixed with terms such as a block, an area, or the like. In a typical case, an M×N block may represent a set of samples or transform coefficients arranged in M columns and N rows.

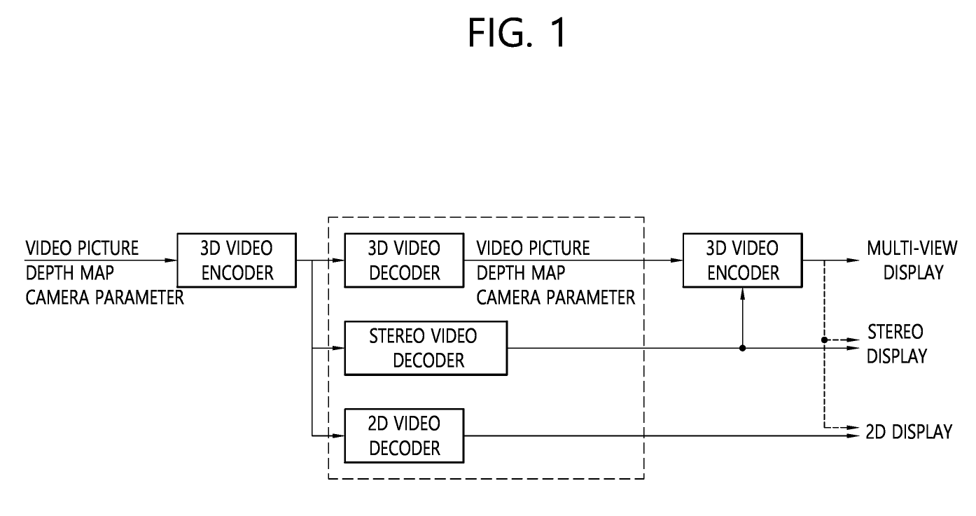

FIG. 1 briefly illustrates a 3 dimensional (3D) video encoding and decoding process to which the present invention is applicable.

Referring to FIG. 1, a 3D video encoder may encode a video picture, a depth map, and a camera parameter to output a bitstream.

The depth map may be constructed of distance information (depth information) between a camera and a subject with respect to a picture of a corresponding video picture (texture picture). For example, the depth map may be an image obtained by normalizing depth information according to a bit depth. In this case, the depth map may be constructed of depth information recorded without a color difference representation. The depth map may be called a depth map picture or a depth picture.

In general, a distance to the subject and a disparity are inverse proportional to each other. Therefore, disparity information indicating an inter-view correlation may be derived from the depth information of the depth map by using the camera parameter.

A bitstream including the depth map and the camera parameter together with a typical color image, i.e., a video picture (texture picture), may be transmitted to a decoder through a network or a storage medium.

From a decoder side, the bitstream may be received to reconstruct a video. If a 3D video decoder is used in the decoder side, the 3D video decoder may decode the video picture, the depth map, and the camera parameter from the bitstream. Views required for a multi-view display may be synthesized on the basis of the decoded video picture, depth map, and camera parameter. In this case, if a display in use is a stereo display, a 3D image may be displayed by using pictures for two views among reconstructed multi-views.

If a stereo video decoder is used, the stereo video decoder may reconstruct two pictures to be incident to both eyes from the bitstream. In a stereo display, a stereoscopic image may be displayed by using a view difference or disparity of a left image which is incident to a left eye and a right image which is incident to a right eye. When a multi-view display is used together with the stereo video decoder, a multi-view may be displayed by generating different views on the basis of reconstructed two pictures.

If a 2D decoder is used, a 2D image may be reconstructed to output the image to a 2D display. If the 2D display is used but the 3D video decoder or the stereo video decoder is used as the decoder, one of the reconstructed images may be output to the 2D display.

In the structure of FIG. 1, a view synthesis may be performed in a decoder side or may be performed in a display side. Further, the decoder and the display may be one device or may be separate devices.

Although it is described for convenience in FIG. 1 that the 3D video decoder and the stereo video decoder and the 2D video decoder are separate decoders, one decoding device may perform all of the 3D video decoding, the stereo video decoding, and the 2D video decoding. Further, the 3D video decoding device may perform the 3D video decoding, the stereo video decoding device may perform the stereo video decoding, and the 2D video decoding device may perform the 2D video decoding. Further, the multi-view display may output the 2D video or may output the stereo video.

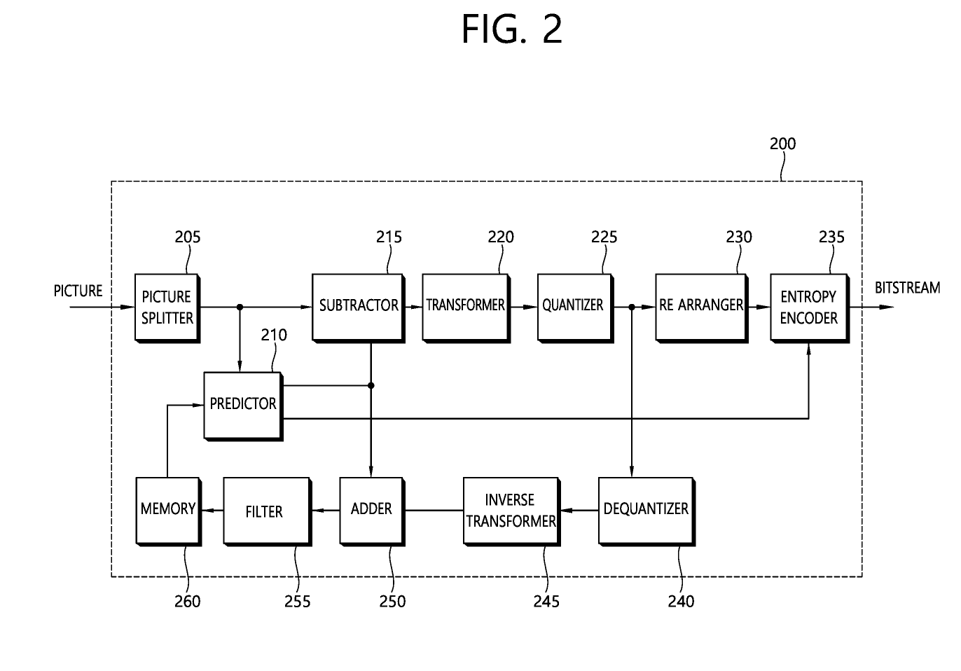

FIG. 2 briefly illustrates a structure of a video encoding device to which the present invention is applicable.

Referring to FIG. 2, a video encoding device 200 includes a picture splitter 205, a predictor 210, a subtractor 215, a transformer 220, a quantizer 225, a re-arranger 230, an entropy encoder 235, a dequantizer 240, an inverse transformer 245, an adder 250, a filter 255, and a memory 260.

The picture splitter 205 may split an input picture into at least one processing unit block. In this case, the processing unit block may be a coding unit block, a prediction unit block, or a transform unit block. As a unit block of coding, the coding unit block may be split from a largest coding unit block according to a quad-tree structure. As a block partitioned from the coding unit block, the prediction unit block may be a unit block of sample prediction. In this case, the prediction unit block may be divided into sub blocks. The transform unit block may be split from the coding unit block according to the quad-tree structure, and may be a unit block for deriving according to a transform coefficient or a unit block for deriving a residual signal from the transform coefficient.

Hereinafter, the coding unit block may be called a coding block (CB) or a coding unit (CU), the prediction unit block may be called a prediction block (PB) or a prediction unit (PU), and the transform unit block may be called a transform block (TB) or a transform unit (TU).

The prediction block or the prediction unit may mean a specific area having a block shape in a picture, and may include an array of a prediction sample. Further, the transform block or the transform unit may mean a specific area having a block shape in a picture, and may include a transform coefficient or an array of a residual sample.

The predictor 210 may perform prediction on a processing target block (hereinafter, a current block), and may generate a prediction block including prediction samples for the current block. A unit of prediction performed in the predictor 210 may be a coding block, or may be a transform block, or may be a prediction block.

The predictor 210 may determine whether intra prediction is applied or inter prediction is applied to the current block. For example, the predictor 210 may determine whether the intra prediction or the inter prediction is applied in unit of CU.

In case of the intra prediction, the predictor 210 may derive a prediction sample for the current block on the basis of a reference sample outside the current block in a picture to which the current block belongs (hereinafter, a current picture). In this case, the predictor 210 may derive the prediction sample on the basis of an average or interpolation of neighboring reference samples of the current block (case (i)), or may derive the prediction sample on the basis of a reference sample existing in a specific (prediction) direction as to a prediction sample among the neighboring reference samples of the current block (case (ii)). The case (i) may be called a non-directional mode, and the case (ii) may be called a directional mode. The predictor 210 may determine the prediction mode to be applied to the current block by using the prediction mode applied to the neighboring block.

In case of the inter prediction, the predictor 210 may derive the prediction sample for the current block on the basis of a sample specified by a motion vector on a reference picture. The predictor 210 may derive the prediction sample for the current block by applying any one of a skip mode, a merge mode, and a motion vector prediction (MVP) mode. In case of the skip mode and the merge mode, the predictor 210 may use motion information of the neighboring block as motion information of the current block. In case of the skip mode, unlike in the merge mode, a difference (residual) between the prediction sample and an original sample is not transmitted. In case of the MVP mode, a motion vector of the neighboring block is used as a motion vector predictor and thus is used as a motion vector predictor of the current block to derive a motion vector of the current block.

In case of the inter prediction, the neighboring block includes a spatial neighboring block existing in the current picture and a temporal neighboring block existing in the reference picture. The reference picture including the temporal neighboring block may also be called a collocated picture (colPic). Motion information may include the motion vector and the reference picture. If the motion information of the temporal neighboring block is used in the skip mode and the merge mode, a top picture on a reference picture list may be used as the reference picture.

A multi-view may be divided into an independent view and a dependent view. In case of encoding for the independent view, the predictor 210 may perform not only inter prediction but also inter-view prediction.

The predictor 210 may configure the reference picture list by including pictures of different views. For the inter-view prediction, the predictor 210 may derive a disparity vector. Unlike in the motion vector which specifies a block corresponding to the current block in a different picture in the current view, the disparity vector may specify a block corresponding to the current block in another view of the same access unit (AU) as the current picture. In the multi-view, for example, the AU may include video pictures and depth maps corresponding to the same time instance. Herein, the AU may mean a set of pictures having the same picture order count (POC). The POC corresponds to a display order, and may be distinguished from a coding order.

The predictor 210 may specify a depth block in a depth view on the basis of the disparity vector, and may perform merge list configuration, an inter-view motion prediction, residual prediction, illumination compensation (IC), view synthesis, or the like.

The disparity vector for the current block may be derived from a depth value by using a camera parameter, or may be derived from a motion vector or disparity vector of a neighboring block in a current or different view.

For example, the predictor 210 may add, to the merging candidate list, an inter-view merging candidate (IvMC) corresponding to temporal motion information of a reference view, an inter-view disparity vector candidate (IvDC) corresponding to a disparity vector, a shifted IvMC derived by a shift of a disparity vector, a texture merging candidate (T) derived from a corresponding texture picture when a current block is a block on a depth map, a disparity derived merging candidate (D) derived by using a disparity from the texture merging candidate, a view synthesis prediction candidate (VSP) derived on the basis of view synthesis, or the like.

In this case, the number of candidates included in the merging candidate list to be applied to the dependent view may be limited to a specific value.

Further, the predictor 210 may predict the motion vector of the current block on the basis of the disparity vector by applying the inter-view motion vector prediction. In this case, the predictor 210 may derive the disparity vector on the basis of a conversion of a largest depth value in a corresponding depth block. When a position of a reference sample in a reference view is specified by adding the disparity vector to a sample position of the current block in the reference view, a block including the reference sample may be used as a reference block. The predictor 210 may use the motion vector of the reference block as a candidate motion parameter of the current block or a motion vector predictor candidate, and may use the disparity vector as a candidate disparity vector for a disparity compensated prediction (DCP).

The subtractor 215 generates a residual sample which is a difference between an original sample and a prediction sample. If the skip mode is applied, the residual sample may not be generated as described above.

The transformer 220 transforms a residual sample in unit of a transform block to generate a transform coefficient. The quantizer 225 may quantize the transform coefficients to generate a quantized transform coefficient.

The re-arranger 230 re-arranges the quantized transform coefficients. The re-arranger 230 may re-arrange the quantized transform coefficients having a block shape in a 1D vector form by using a scanning method.

The entropy encoder 235 may perform entropy-encoding on the quantized transform coefficients. The entropy encoding may include an encoding method, for example, an exponential Golomb, a context-adaptive variable length coding (CAVLC), a context-adaptive binary arithmetic coding (CABAC), or the like. The entropy encoder 235 may perform encoding together or separately on information (e.g., a syntax element value or the like) required for video reconstruction in addition to the quantized transform coefficients. The entropy-encoded information may be transmitted or stored in unit of a network abstraction layer (NAL) in a bitstream form.

The adder 250 adds the residual sample and the prediction sample to reconstruct the picture. The residual sample and the prediction sample may be added in unit of blocks to generate a reconstruction block. Although it is described herein that the adder 250 is configured separately, the adder 250 may be a part of the predictor 210.

The filter 255 may apply deblocking filtering and/or a sample adaptive offset to the reconstructed picture. An artifact of a block boundary in the reconstructed picture or a distortion in a quantization process may be corrected through the deblocking filtering and/or the sample adaptive offset. The sample adaptive offset may be applied in unit of samples, and may be applied after a process of the deblocking filtering is complete.

The memory 260 may store the reconstructed picture or information required for encoding/decoding. For example, the memory 260 may store (reference) pictures used in inter prediction/inter-view prediction. In this case, pictures used in the inter prediction/inter-view prediction may be designated by a reference picture set or a reference picture list.

Although it is described herein that one encoding device encodes an independent view and a dependent view, this is for convenience of explanation. Thus, a separate encoding device may be configured for each view, or a separate internal module (e.g., a prediction module for each view) may be configured for each view.

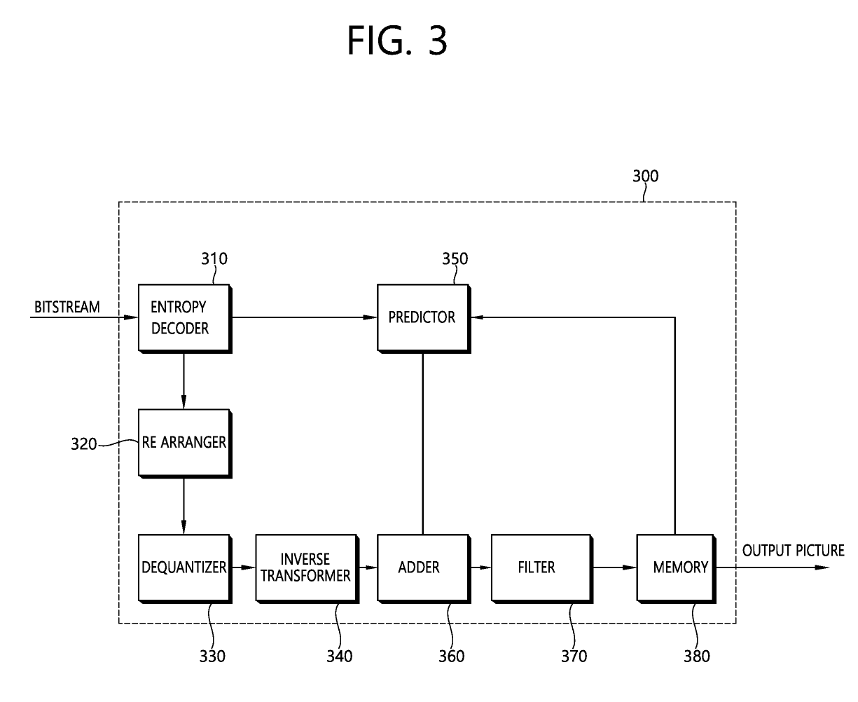

FIG. 3 briefly illustrates a structure of a video decoding device to which the present invention is applicable.

Referring to FIG. 3, a video decoding device 300 includes an entropy decoder 310, a re-arranger 320, a dequantizer 330, an inverse transformer 340, a predictor 350, an adder 360, a filter 370, and a memory 380.

When a bitstream including video information is input, the video decoding device 300 may reconstruct a video in association with a process by which video information is processed in the video encoding device.

For example, the video decoding device 300 may perform video decoding by using a processing unit applied in the video encoding device. Therefore, the processing unit block of video decoding may be a coding unit block, a prediction unit block, or a transform unit block. As a unit block of decoding, the coding unit block may be split according to a quad tree structure from a largest coding unit block. As a block partitioned from the coding unit block, the prediction unit block may be a unit block of sample prediction. In this case, the prediction unit block may be divided into sub blocks. As a coding unit block, the transform unit block may be split according to the quad tree structure, and may be a unit block for deriving a transform coefficient or a unit block for deriving a residual signal from the transform coefficient.

The entropy decoder 310 may parse the bitstream to output information required for video reconstruction or picture reconstruction. For example, the entropy decoder 310 may decode information in the bitstream on the basis of a coding method such as exponential Golomb encoding, CAVLC, CABAC, or the like, and may output a value of a syntax element required for video reconstruction and a quantized value of a transform coefficient regarding a residual.

If a plurality of views are processed to reproduce a 3D video, the bitstream may be input for each view. Alternatively, information regarding each view may be multiplexed in the bitstream. In this case, the entropy decoder 310 may de-multiplex the bitstream to parse it for each view.

The re-arranger 320 may re-arrange quantized transform coefficients in a form of a 2D block. The re-arranger 320 may perform re-arrangement in association with coefficient scanning performed in an encoding device.

The dequantizer 330 may de-quantize the quantized transform coefficients on the basis of a (de)quantization parameter to output a transform coefficient. In this case, information for deriving a quantization parameter may be signaled from the encoding device.

The inverse transformer 340 may inverse-transform the transform coefficients to derive residual samples.

The predictor 350 may perform prediction on a current block, and may generate a prediction block including prediction samples for the current block. A unit of prediction performed in the predictor 350 may be a coding block or may be a transform block or may be a prediction block.

The predictor 350 may determine whether to apply intra prediction or inter prediction. In this case, a unit for determining which one will be used between the intra prediction and the inter prediction may be different from a unit for generating a prediction sample. In addition, a unit for generating the prediction sample may also be different in the inter prediction and the intra prediction. For example, which one will be applied between the inter prediction and the intra prediction may be determined in unit of CU. Further, for example, in the inter prediction, the prediction sample may be generated by determining the prediction mode in unit of PU, and in the intra prediction, the prediction sample may be generated in unit of TU by determining the prediction mode in unit of PU.

In case of the intra prediction, the predictor 350 may derive a prediction sample for a current block on the basis of a neighboring reference sample in a current picture. The predictor 350 may derive the prediction sample for the current block by applying a directional mode or a non-directional mode on the basis of the neighboring reference sample of the current block. In this case, a prediction mode to be applied to the current block may be determined by using an intra prediction mode of a neighboring block.

In case of the inter prediction, the predictor 350 may derive the prediction sample for the current block on the basis of a sample specified on a reference picture by a motion vector on the reference picture. The predictor 350 may derive the prediction sample for the current block by applying any one of a skip mode, a merge mode, and an MVP mode.

In case of the skip mode and the merge mode, motion information of the neighboring block may be used as motion information of the current block. In this case, the neighboring block may include a spatial neighboring block and a temporal neighboring block.

The predictor 350 may construct a merging candidate list by using motion information of an available neighboring block, and may use information indicated by a merge index on the merging candidate list as a motion vector of the current block. The merge index may be signaled from the encoding device. The motion information may include the motion vector and the reference picture. When motion information of the temporal neighboring block is used in the skip mode and the merge mode, a highest picture on the reference picture list may be used as the reference picture.

In case of the skip mode, unlike in the merge mode, a difference (residual) between the prediction sample and the original sample is not transmitted.

In case of the MVP mode, the motion vector of the current block may be derived by using the motion vector of the neighboring block as a motion vector predictor. In this case, the neighboring block may include a spatial neighboring block and a temporal neighboring block.

In case of the dependent view, the predictor 350 may perform inter-view prediction. In this case, the predictor 350 may configure the reference picture list by including pictures of different views.

For the inter-view prediction, the predictor 350 may derive a disparity vector. The predictor 350 may specify a depth block in a depth view on the basis of the disparity vector, and may perform merge list configuration, an inter-view motion prediction, residual prediction, illumination compensation (IC), view synthesis, or the like.

The disparity vector for the current block may be derived from a depth value by using a camera parameter, or may be derived from a motion vector or disparity vector of a neighboring block in a current or different view. The camera parameter may be signaled from the encoding device.

When the merge mode is applied to the current block of the dependent view, the predictor 350 may add, to the merging candidate list, an IvMC corresponding to temporal motion information of a reference view, an IvDC corresponding to a disparity vector, a shifted IvMC derived by a shift of a disparity vector, a texture merging candidate (T) derived from a corresponding texture picture when a current block is a block on a depth map, a disparity derived merging candidate (D) derived by using a disparity from the texture merging candidate, a view synthesis prediction candidate (VSP) derived on the basis of view synthesis, or the like.

In this case, the number of candidates included in the merging candidate list to be applied to the dependent view may be limited to a specific value.

Further, the predictor 350 may predict the motion vector of the current block on the basis of the disparity vector by applying the inter-view motion vector prediction. In this case, the predictor 350 may use a block in a reference view specified by the disparity vector as a reference block. The predictor 350 may use the motion vector of the reference block as a candidate motion parameter or a motion vector predictor candidate of the current block, and may use the disparity vector as a candidate vector for disparity compensated prediction (DCP).

The adder 360 may add the residual sample and the prediction sample to reconstruct the current block or the current picture. The adder 360 may add the residual sample and the prediction sample in unit of blocks to reconstruct the current picture. When the skip mode is applied, a residual is not transmitted, and thus the prediction sample may be a reconstruction sample. Although it is described herein that the adder 360 is configured separately, the adder 360 may be a part of the predictor 350.

The filter 370 may apply de-blocking filtering and/or a sample adaptive offset to the reconstructed picture. In this case, the sample adaptive offset may be applied in unit of samples, and may be applied after de-blocking filtering.

The memory 380 may store a reconstructed picture and information required in decoding. For example, the memory 380 may store pictures used in inter prediction/inter-view prediction. In this case, pictures used in the inter prediction/inter-view prediction may be designated by a reference picture set or a reference picture list. The reconstructed picture may be used as a reference picture for a different picture.

Further, the memory 380 may output the reconstructed picture according to an output order. Although not shown, an output unit may display a plurality of different views to reproduce a 3D image.

Although it is described in the example of FIG. 3 that an independent view and a dependent view are decoded in one decoding device, this is for exemplary purposes only, and the present invention is not limited thereto. For example, each decoding device may operate for each view, and an internal module (for example, a prediction module) may be provided in association with each view in one decoding device.

Multi-view video coding may perform coding on a current picture by using decoding data of a different view belonging to the same access unit (AU) as the current picture to increase video coding efficiency for the current view.

In the multi-view video decoding, views may be coded in unit of AU, and pictures may be coded in unit of views. Coding is performed between views according to a determined order. A view which can be coded without a reference of another view may be called a base view or an independent view. Further, a view which can be coded with reference to an independent view or another view after the independent view is coded may be called a dependent view or an extended view. Further, if the current view is a dependent view, a view used as a reference in coding of the current view may be called a reference view. Herein, coding of a view includes coding of a video picture, a depth map, or the like belonging to the view.

The 3D video includes a texture picture having general color image information and a depth map having depth information on the texture picture.

The depth map may be coded by referring to coding information of the texture picture at the same point of time (the same time). In other words, the depth map may be coded by referring to the coding information of the texture picture having the same POC as the depth picture.

Since the depth map is acquired through simultaneous pick-up with the texture picture at the same time or generated by calculating the depth information of the texture picture at the same time, the depth map and the texture picture at the same time have a very high correlation.

Accordingly, in coding the depth map, information on the texture picture which has already been coded, for example, block partition information or motion information of the texture picture may be used. As one example, the motion information of the texture amp may be similarly used in the depth picture and this is referred to as motion parameter inheritance (MPI). In particular, a method for inheriting a motion vector from the texture picture is referred to as motion vector inheritance (MVI). In the MVI, the motion vector of a corresponding texture block is induced to be used as a motion prediction vector of a current block of the depth map.

Meanwhile, the depth map stores a distance which each pixel has as a gray scale and there are a lot of cases in which a minute depth difference between respective pixels is not large and the depth map may be expressed while being divided into two types of a foreground and a background in one block. Further, the depth map shows a characteristic in that the depth map has a sharp edge on a boundary of an object and has an almost constant value (e.g., a constant value) at a position other than the boundary.

Accordingly, since an intra prediction method used for predicting the texture picture in the related art is a prediction method suitable for a region (constant region) having a predetermined value, the intra prediction method is not effective in predicting the depth map having a different characteristic from the texture picture.

Therefore, in coding the depth map, a new intra prediction mode to reflect the characteristic of the depth map may be used. For example, in the intra prediction mode for the depth map, the current block (alternatively, depth block) of the depth map is expressed as two non-rectangular models and each region may be expressed as the constant value. In order to express the model, information indicating how the corresponding block is partitioned and information indicating which value each partition is filled with are required. A partitioning method includes Wedgelet and counter methods and the Wedgelet method is a method in which the current block is separated into two regions (partitions) based on a straight-line shape and the counter method is a method in which the current block is separated into two regions (partitions) based on a predetermined curve shape.

Meanwhile, since the depth map has a characteristic of having almost the same value in a position other than a boundary, the depth map is highly likely to be monotonous and similar to a neighboring block. By using such a characteristic, decoded reference samples around a current block may be regarded as a candidate, and one of them may be used as a representative sample value of the current block. This may be called a single sample mode (SSM) or a single depth mode (SDM). The SDM (or SSM) may also be applied to the depth map, and may also be applied to a texture picture or the like having a monotonous color by considering compatibility and efficiency. In the SDM, the current block may be (intra) predicted on the basis of SDM flag information regarding whether the SDM is applied to the current block and single sample index information indicating which reference sample is indicated (or selected) in a candidate list for the SDM. That is, predict samples of the current block may be generated on the basis of a value of a reference sample indicated by the single sample index.

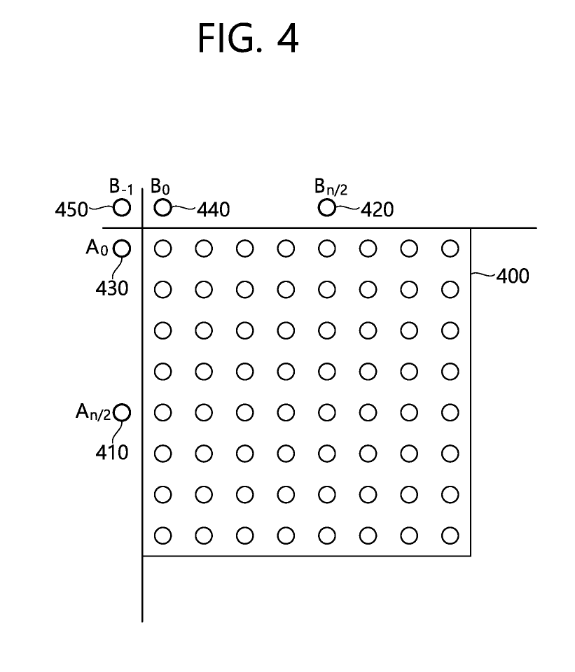

FIG. 4 is a diagram for schematically describing an intra prediction method of a current block in a depth map in a single depth mode (SDM).

Referring to FIG. 4, when a current block 400 to be intra-predicted in the depth map is intra-predicted by the SDM, the current block 400 may be filled with one depth value.

In this case, instead of directly receiving the depth map for filling the current block 400, the decoding device may configure a sample candidate list on the basis of neighboring samples adjacent to the current block 400 and receive single sample index information indicating a specific candidate among the configured sample candidate list to derive the depth value for filling the current block 400. The neighboring samples may be previously reconstructed samples.

To configure the sample candidate list, A_{n/2} 410, B_{n/2} 420, A₀ 430, B₀ 440, and B₋₁ 450 may be used as neighboring reference samples. Herein, the A_{n/2} 410 and the A₀ 430 are located at a left side of the current block 400, the B_{n/2} 420 and the B₀ 440 are located at an upper side of the current block 400, and the B₋₁ 450 is located at an upper left side of the current block 400. The current block may consist of an even number of samples horizontally (an x-axis) and vertically (a y-axis) such as 8×8, 16×16, 32×32, etc. In this case, the A_{n/2} 410 may be a sample located in a lower side of one of two samples located at the center in a direction of the y-axis among samples adjacent to a left boundary of the current block 400, and the A₀ 430 may be a sample located to an uppermost side among the samples adjacent to the left boundary of the current block 400. The B_{n/2} 420 may be a sample located to the right of two samples located at the center in a direction of the x-axis among samples adjacent to an upper boundary of the current block 400, and the B₀ 440 may be a sample located to a leftmost side among the samples adjacent to the upper boundary of the current block 410.

Herein, for example, a size of the sample candidate list may be fixed to 2. That is, up to two candidates may be derived on the basis of the neighboring reference samples. Among the neighboring reference samples A_{n/2} 410, B_{n/2} 420, A₀ 430, B₀ 440, B₋₁ 450, etc., there may be samples which are unavailable or which have the same depth value. In this case, two neighboring reference samples (available and having different depth values) may be inserted (or allocated) to a candidate list on the basis of a predetermined search order. For example, if the current block is adjacent to a boundary of the depth map or is adjacent to a boundary of an independent slice, a neighboring reference sample at a search location may not be present or may be located beyond the slice. In this case, it may be regarded that the neighboring reference sample is not available. The search order may be the A_{n/2} 410, the B_{n/2} 420, the A₀ 430, the B₀ 440, and the B₋₁ 450.

Meanwhile, even after the procedure of deriving candidates is performed on the basis of the (spatial) neighboring reference samples, an empty entry may still exist in the sample candidate list. For example, even after the procedure of deriving the candidates is performed, if all of the neighboring reference samples are not available or only one of them is available, at least one candidate of the candidate sample candidate list remains as the empty entry. In this case, the empty entry may be filled as follows.

If a sample candidate of an index 0 of the sample candidate list is the empty entry, a value indicated by a sample candidate of the index 0 may be set to a middle value of a depth value range. Herein, the middle value may be expressed by “1<<(BitDepth_{Y}−1)”. Herein, BitDepth_{Y} may be a bit depth configured for a luma sample.

If the sample candidate of the index 1 of the sample candidate list is the empty entry, a value indicated by the sample candidate of the index 1 may be set to a value obtained by adding 1 to a value indicated by the sample candidate of the index 0. For example, if the sample candidate of the index 0 has a value derived from a neighboring reference sample, a value obtained by adding 1 to the derived value may be set to a value of the sample candidate of the index 1. For another example, if the sample candidate of the index 0 is originally the empty index and has the middle value of the depth value range, the candidate of the index 1 may have a value obtained by adding 1 to the middle value.

In this case, if the sample candidate of the index 0 is derived from the neighboring reference sample and has a maximum value of the depth value range, the sample candidate of the index 1 may have an incorrect value. Therefore, in order to avoid such a case, a range of a value of the sample candidate of the index 1 must be limited in the range of 0 and (1<<bitDepth_{Y})−1 through clipping.

The aforementioned method of filling the empty list of the candidate sample candidate list according to the present invention may be described by the following table.

TABLE 1

if( numCand == 0 )
sampleCandList[ numCand++ ] = ( 1 << ( BitDepthY − 1 ) )
if( numCand == 1 )
sampleCandList[ numCand++ ] = Clip3( 0, ( 1 << bitDepth ) − 1,
sampleCandList[ 0 ] + 1)

Herein, numCand denotes an index number of a sample candidate in the candidate sample candidate list, sampleCandList[0] denotes a sample candidate of the index 0, and sampleCandList[1] denotes a sample candidate of the index 1.

Herein, it is apparent that a Clip3 operation can be expressed by Equation 1 as follows.

$$Clip 3 ( x , y , z ) = \{ \begin{matrix}x & ; & z < x \\ y & ; & z > y \\ z & ; & otherwise\end{matrix} \qquad [ Equation 1 ]$$

Meanwhile, an intra skip mode may be used to increase efficiency of intra coding. In a skip mode of an inter mode (hereinafter, an inter skip mode), motion compensation is performed on a block by using motion information (a reference picture list, a motion vector, etc.) indicated by a merge index in the merge candidate list, and residual coding (i.e., residual sample addition) for the block is skipped. In case of the inter mode, motion information of a reference picture stored in a decoded picture buffer may be referred to, whereas in case of the intra mode, information on a time axis cannot be used, and motion information of a block which exists spatially in proximity can be used. If the intra skip mode is applied to the current block, residual information (a residual signal) is not transmitted for the current block. The SDM mode may also be used as one type of the intra skip mode.

In case of the intra skip mode, a candidate list may be used to indicate motion information of the block which exists spatially in proximity The candidate list may represent coding information for intra prediction of the current block in a list form.

The candidate list used for the intra skip mode may include at least one of an intra prediction mode of the neighboring block and a reconstructed sample (picture) value. Herein, the intra prediction mode indicates a directional/non-directional prediction mode. The directional prediction mode may be configured of 33 directional intra prediction directions, and for example, may include a horizontal direction mode, a vertical direction mode, a diagonal direction mode, or the like. The non-directional prediction mode may include a planer mode, a DC mode, or the like.

In addition, an intra motion vector may be applied in the intra mode. In this case, the intra motion vector and a template for the intra motion vector may be used for the intra prediction. The template for the intra prediction may be predetermined by using the motion vector as an input value. In this case, information regarding the template for the intra prediction may be indicated by the candidate list.

There may be several methods for transmitting coding information used for the current block in the candidate list to the decoder. For example, the coding information used for the current block in the candidate list may be indicated by index information, and the index information may be transmitted from the encoder to the decoder. For another example, the coding information used for the current block in the candidate list may be indicated implicitly through the same procedure in the encoder and the decoder. For another example, the decoder may use the coding information of a specific order according to a criterion in the candidate list.

In the present invention, a reference of a picture which exists on the same AU at the same time (herein, the picture may include a depth picture) may be regarded as an intra reference. That is, in case of coding the depth picture (a depth map), coding information of a texture picture corresponding thereto may be included in the candidate list. Further, if the depth picture is coded prior to the texture picture by applying a flexible coding order, the coding information of the depth picture may be included in the candidate list when coding the texture picture. Furthermore, since the depth picture shows a characteristic of having almost the same value at a location other than a boundary and is highly likely to be monotonous and similar to a neighboring block, a reconstructed sample (picture) value around the current block may be directly included in the candidate list for the intra skip mode.

The number of candidate lists for the intra skip mode may be fixed or various. The number of candidates may be predetermined to a specific value. Alternatively, the number of candidates may be defined by a high level syntax, or information regarding the number of candidates may be explicitly transmitted from the encoder to the decoder.

The candidate list may be configured based on candidates of a specific order. In this case, an order of candidates of the candidate list may be determined according to a characteristic of the coding information. For example, the coding information may include at least one of a reconstructed sample value, a directional prediction mode, an intra motion vector, and a template index, and a candidate order of the candidate list may be determined according to which information is included in the coding information. The coding information may be selected on the basis of the candidate list, and the selected coding information may be coded by using CABAC and CAVLC methods, or may be coded by using a bypass method instead of applying the CABAC and CAVLC methods.

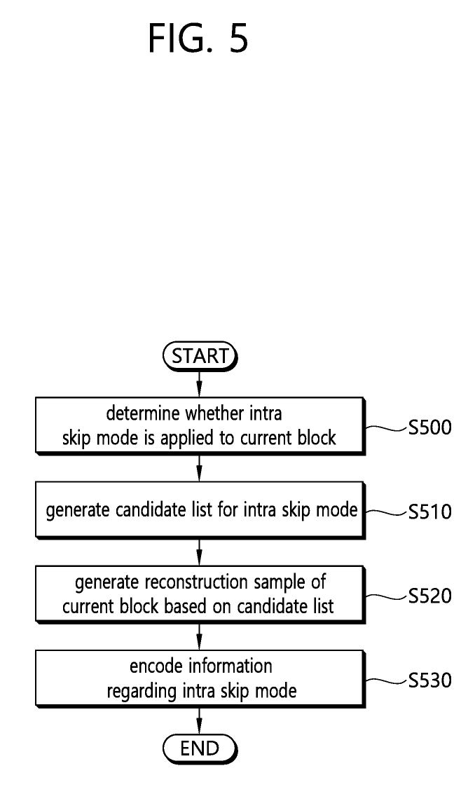

FIG. 5 is a flowchart briefly illustrating an encoding method based on an intra skip mode according to an embodiment of the present invention. The method of FIG. 5 may be performed by the aforementioned video encoding device of FIG. 2.

Referring to FIG. 5, the encoding device determines whether an intra skip is applied to a current block on a depth map (S500). The encoding device may compare coding efficiency by applying various prediction methods, and may determine an optimal prediction method according to a determined criterion. The encoding device may determine that an intra skip mode is applied among various prediction modes for predicting the current block. The current block may be a CU.

When the intra skip mode is applied to the current block, the encoding device generates a candidate list for the intra skip mode (S510). The encoding device may use neighboring reference samples of the current block to generate the candidate list, and may use the neighboring reference blocks of the current block to generate the candidate list. In this case, intra prediction mode information of the neighboring reference blocks may be used, and the intra prediction mode may include a directional prediction mode (e.g., a horizontal direction mode, a vertical direction mode, and a diagonal direction mode) or the like.

If the current block is present on the texture picture, the neighboring block may be present on a depth picture having the same view ID as the texture picture. If the current block is present on the depth picture, the neighboring block is present on a texture picture having the same view ID as the depth picture.

The encoding device may generate the candidate list on the basis of at least one of intra motion vector information and predefined template information.

The number of candidates included in the candidate list may be fixed, or may be determined flexibly. The number of candidates included in the candidate list may be defined by a high level syntax. An indexing order of the candidates included in the candidate list may be determined according to an information characteristic of the candidates.

The candidate list may include a first candidate and a second candidate. The first candidate may be indicated by an index 0. The second candidate may be indicated by an index 1.

If a candidate of the index 0 of the candidate list is an empty entry, a value indicated by a candidate of the index 0 may be set to 1<<(bit depth−1). If a candidate of the index 1 of the candidate list is the empty entry, the value indicated by a candidate of the index 1 may be set to a value obtained by adding 1 to a value indicated by the sample candidate of the index 0. The value indicated by the candidate of the index 1 may be clipped to 0 as a minimum value and (1<<bit depth)−1 as a maximum value.

The encoding device generates a reconstruction sample of the current block on the basis of the candidate list (S520). The encoding device may perform an operation depending on the intra skip mode on the basis of the candidate list to generate the reconstruction sample of the current block. The current block may be a CU. If the CU is coded in the intra skip mode, a residual signal as a difference between an original block for the CU and a predicted block may not be transmitted. That is, if the intra skip mode is applied, a result thereof may be directly the reconstruction block.

The encoding device encodes information regarding the intra skip mode (S530). The encoding device may perform entropy-encoding on the information regarding the intra skip mode to output it as a bit-stream. The output bit-stream may be transmitted through a network or may be stored in a storage medium. The information regarding the intra skip mode may include intra skip flag information indicating whether the intra skip mode is applied to the current block and index information indicating a specific candidate in the candidate list. If a candidate used for the current block can be derived implicitly from the candidate list through the same procedure in the encoding device and the decoding device, the index information may be omitted.

The intra skip flag information may indicate whether the intra skip mode is applied on a CU basis. In addition, the bit-stream may include values of syntax elements for reconstructing the current block.

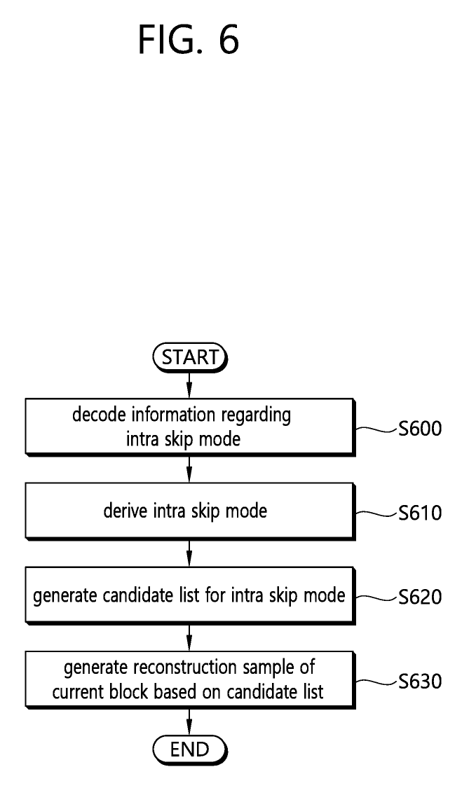

FIG. 6 is a flowchart briefly illustrating a decoding method based on an intra skip mode according to an embodiment of the present invention. The method of FIG. 6 may be performed by the aforementioned video decoding device of FIG. 3.

Referring to FIG. 6, the decoding device decodes information regarding the intra skip mode included in a bit stream (S600). The decoding device may perform entropy decoding on the bit stream, and may acquire the information regarding the intra skip mode. The information regarding the intra skip mode may include intra skip flag information indicating whether the intra skip mode is applied to the current block and index information indicating a specific candidate in the candidate list. If a candidate used for the current block can be derived implicitly from the candidate list through the same procedure in the encoding device and the decoding device, the index information may be omitted.

The bit stream may include values of syntax elements for reconstructing the current block.

The decoding device may derive a prediction mode of the current block as the intra skip mode on the basis of the information regarding the intra skip mode (S610).

The decoding device generates a candidate list for the intra skip mode (S620). The decoding device may use neighboring reference samples of the current block to generate the candidate list, and may use the neighboring reference blocks of the current block to generate the candidate list. In this case, intra prediction mode information of the neighboring reference blocks may be used, and the intra prediction mode may include a directional prediction mode (e.g., a horizontal direction mode, a vertical direction mode, and a diagonal direction mode) or the like.

The decoding device may generate the candidate list on the basis of at least one of intra motion vector information and predefined template information.

The number of candidates included in the candidate list may be fixed, or may be determined flexibly. The number of candidates included in the candidate list may be defined by a high level syntax. An indexing order of the candidates included in the candidate list may be determined according to an information characteristic of the candidates.

The candidate list may include a first candidate and a second candidate. The first candidate may be indicated by an index 0. The second candidate may be indicated by an index 1.

If a candidate of the index 0 of the candidate list is an empty entry, a value indicated by a candidate of the index 0 may be set to 1<<(bit depth−1). If a candidate of the index 1 of the candidate list is the empty entry, the value indicated by a candidate of the index 1 may be set to a value obtained by adding 1 to a value indicated by the sample candidate of the index 0. The value indicated by the candidate of the index 1 may be clipped to 0 as a minimum value and (1<<bit depth)−1 as a maximum value.

The decoding device generates a reconstruction sample of the current block on the basis of the candidate list (S630). The decoding device may generate the reconstruction sample of the current block on the basis of the candidate list. The current block may be a CU. If the CU is coded in the intra skip mode, a residual signal as a difference between an original block for the CU and a predicted block may not be signaled. That is, in this case, a block decoded according to the intra skip mode may be the reconstruction block.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation, and do not intend to limit technical scopes of the present invention. Therefore, the scope of the invention should be defined by the appended claims.

When the above-described embodiments are implemented in software in the present invention, the above-described scheme may be implemented using a module (process or function) which performs the above function. The module may be stored in the memory and executed by the processor. The memory may be disposed to the processor internally or externally and connected to the processor using a variety of well-known means.

What is claimed is:

1. A 3 dimensional (3D) video decoding method comprising:
decoding information on an intra skip mode for a current block;
deriving a prediction mode of the current block as the intra skip mode on the basis of the information on the intra skip mode;
generating a candidate list for the intra skip mode; and
generating a reconstruction sample of the current block on the basis of the candidate list.

2. The 3D video decoding method of claim 1, wherein the candidate list comprises at least one of intra prediction mode information of a neighboring block of the current block and information of a value of a neighboring sample of the current block.

3. The 3D video decoding method of claim 2, wherein if the current block is present on a texture picture, the neighboring block is present on a depth picture having the same view ID as the texture picture.

4. The 3D video decoding method of claim 2, wherein if the current block is present on the depth picture, the neighboring block is present on a texture picture having the same view ID as the depth picture.

5. The 3D video decoding method of claim 2, wherein the intra prediction mode information comprises directional prediction mode information.

6. The 3D video decoding method of claim 1, wherein the candidate list comprises at least one of intra motion vector information and predefined template information.

7. The 3D video decoding method of claim 1,
wherein the current block is a coding unit (CU), and
wherein information regarding the intra skip mode indicates whether the intra skip mode is applied on a CU basis.

8. The 3D video decoding method of claim 1,
wherein information on the intra skip mode comprises index information, and
wherein a specific candidate for the current block is indicated on the candidate list on the basis of the index information.

9. The 3D video decoding method of claim 1, wherein the number of candidates comprised in the candidate list is fixed.

10. The 3D video decoding method of claim 1, wherein the number of candidates comprised in the candidate list is defined by a high level syntax.

11. The 3D video decoding method of claim 1, wherein an indexing order of the candidates comprised in the candidate list is determined according to an information characteristic of the candidates.

12. The 3D video decoding method of claim 1, wherein, if a candidate of the index 0 of the candidate list is an empty entry, a value indicated by the candidate of the index 0 is set to 1<<(bit depth−1).

13. The 3D video decoding method of claim 1, wherein, if a candidate of the index 1 of the candidate list is an empty entry, the value indicated by the candidate of the index 1 is set to a value obtained by adding 1 to a value indicated by the sample candidate of the index 0.

14. The 3D video decoding method of claim 13, wherein the value indicated by the candidate of the index 1 is clipped to 0 as a minimum value and (1<<bit depth)−1 as a maximum value.
